(19) United States
(12) Patent Application Publication
(10) Pub. No.: US 2023/0361321 A1
(43) Pub. Date: Nov. 9, 2023

(54) FUEL CELL POWER SYSTEM INCLUDING AIR FLOW CONTROL AND METHOD OF OPERATING THEREOF

(71) Applicant: BLOOM ENERGY CORPORATION, San Jose, CA (US)

(72) Inventors: David WEINGAERTNER, Sunnyvale, CA (US); Shannon BELL, San Jose, CA (US); Natarajan RAMANAN, San Jose, CA (US)

(21) Appl. No.: 18/310,793

(22) Filed: May 2, 2023

Related U.S. Application Data
(60) Provisional application No. 63/364,073, filed on May 3, 2022.

(51) Int. Cl. H01M 8/04007; H01M 8/04014; H01M 8/0438; H01M 8/04701

(52) U.S. Cl. CPC H01M 8/04074; H01M 8/04014; H01M 8/0441; H01M 8/04402; H01M 8/04738; H01M 2250/20

(57) ABSTRACT

A method of operating power system includes generating compressed air, providing the compressed air and fuel to fuel cell power modules, and providing a cathode exhaust from the power modules to a heat exchanger.

### FIELD

Aspects of the present invention relate to fuel cell power systems including a compression system configured to provide pressurized air to fuel cell power modules.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a power system comprises power modules comprising stacks of fuel cells, a compression system configured to generate compressed air, an air conduit configured to transfer compressed air from the compression system to the power modules, a heat exchanger configured to extract heat from cathode exhaust generated by the power modules, and an exhaust conduit configured to transfer the cathode exhaust from the power modules to the heat exchanger.

According to various embodiments, a power system comprises power modules comprising stacks of fuel cells, a heat exchanger configured to extract heat from cathode exhaust generated by the power modules, an exhaust conduit configured to transfer the cathode exhaust from the power modules to the heat exchanger, and a fan configured to force cathode exhaust through the exhaust conduit.

An embodiment method of operating power system includes generating compressed air, providing the compressed air and fuel to fuel cell power modules, and providing a cathode exhaust from the power modules to a heat exchanger.

Additional embodiments include heating water on a ship in the heat exchanger using the cathode exhaust, and/or cooling the compressed air and storing the cooled compressed air prior to providing the compressed air to the fuel cell power modules, and generating electrical power in the fuel cell power modules using the fuel and the compressed air.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic of a fuel cell power module, according to various embodiments of the present disclosure.

FIG. 2 is a schematic view of a power system including power modules of FIG. 1, according to various embodiments of the present disclosure.

FIGS. 3-6 are schematic views of alternative power systems, according to various alternative embodiments of the present disclosure.

FIG. 7 is a schematic view of a vessel including the power system according to various embodiments of the present disclosure.

### DETAILED DESCRIPTION

As set forth herein, various aspects of the disclosure are described with reference to the exemplary embodiments and/or the accompanying drawings in which exemplary embodiments of the invention are illustrated. This invention may, however, be embodied in many different forms and should not be construed as limited to the exemplary embodiments shown in the drawings or described herein. It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

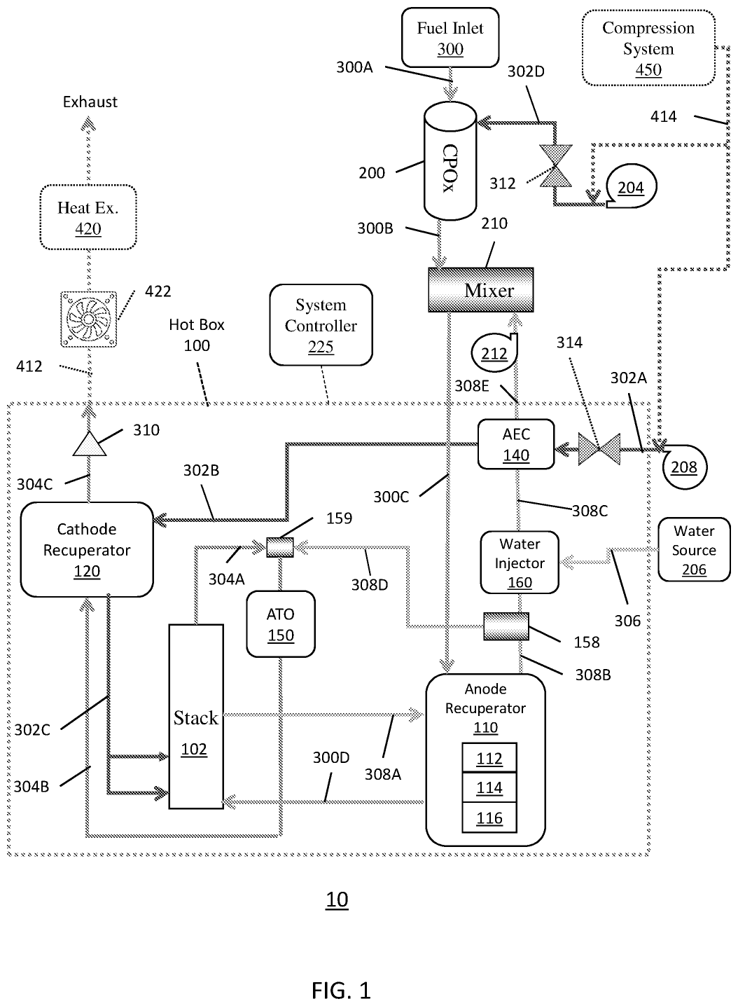

FIG. 1 is a schematic representation of a SOFC system power module 10, according to various embodiments of the present disclosure. Referring to FIG. 1, the power module 10 includes a hotbox 100 and various components disposed therein or adjacent thereto. The hot box 100 may contain stacks 102 containing fuel cells, such as solid oxide fuel cells, separated by interconnects. Solid oxide fuel cells of the stack 102 may contain a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be internally or externally manifolded for fuel.

The hot box 100 may also contain an anode recuperator heat exchanger 110, a cathode recuperator heat exchanger 120, an anode tail gas oxidizer (ATO) 150, an anode exhaust cooler heat exchanger 140, a splitter 158, a vortex generator 159, and a water injector 160. The module 10 may also include a catalytic partial oxidation (CPOx) reactor 200, a mixer 210, and an anode recycle blower 212, which may be disposed outside of the hotbox 100. The module may optionally include at least one of a CPOx blower 204 (e.g., air blower) and/or a main air blower 208 (e.g., system blower). However, in some embodiments, the CPOx blower 204 and/or the main air blower 208 may be omitted, and one or both of them may be replaced by a compression system 450, as will be described in more detail below. The compression system 450 may be located in the module 10 or may be located external to the module 10. Furthermore, the present disclosure is not limited to any particular location for each of the components with respect to the hotbox 100.

The CPOx reactor 200 receives a fuel inlet stream from a fuel inlet 300, through fuel conduit 300A. The fuel inlet 300 may be a fuel tank or a utility natural gas line including a valve to control an amount of fuel provided to the CPOx reactor 200. The CPOx blower 204 and/or the compression system 450 may provide air to the CPOx reactor 200 though an air conduit 302D, during system start-up. The fuel and/or air may be provided to the mixer 210 by fuel conduit 300B. Fuel (e.g., the fuel inlet stream) flows from the mixer 210 to the anode recuperator 110 through fuel conduit 300C. The fuel is heated in the anode recuperator 110 by a portion of the fuel exhaust and the fuel then flows from the anode recuperator 110 to the stack 102 through fuel conduit 300D.

The main air blower 208 and/or the compression system 450 may provide an air stream (e.g., air inlet stream) to the anode exhaust cooler 140 through an air inlet conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C.

An anode exhaust stream (e.g., the fuel exhaust stream generated in the stack 102 is provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 158 by anode exhaust conduit 308B. A first portion of the anode exhaust may be provided from the splitter 158 to the anode exhaust cooler 140 through the water injector 160 and the anode exhaust conduit 308C. A second portion of the anode exhaust is provided from the splitter 158 to the ATO 150 through the anode exhaust conduit 308D. The first portion of the anode exhaust heats the air inlet stream in the anode exhaust cooler 140 and may then be provided from the anode exhaust cooler 140 to the mixer 210 through the anode exhaust conduit 308E.

The relative amounts of anode exhaust provided to the ATO 150 and the anode exhaust cooler 140 is controlled by the anode recycle blower 212. The higher the blower 212 speed, the larger portion of the anode exhaust is provided into anode exhaust conduit 308C and a smaller portion of the anode exhaust is provided to the ATO 150 via anode exhaust conduit 308D, and vice-versa.

Cathode exhaust generated in the stack 102 flows to the ATO 150 through exhaust conduit 304A. The vortex generator 159 may be disposed in exhaust conduit 304A and may be configured to swirl the cathode exhaust. The anode exhaust conduit 308D may be fluidly connected to the vortex generator 159 or to the cathode exhaust conduit 304A or the ATO 150 downstream of the vortex generator 159. The swirled cathode exhaust may mix with the second portion of the anode exhaust provided by the splitter 158 before being provided to the ATO 150. The mixture may be oxidized in the ATO 150 to generate an ATO exhaust. The ATO exhaust flows from the ATO 150 to the cathode recuperator 120 through exhaust conduit 304B. Exhaust flows from the cathode recuperator and out of the hotbox 100 through exhaust conduit 304C.

In combined heat and power applications and/or marine applications, the exhaust conduit 304C may be fluidly connected to an optional exhaust conduit (e.g., exhaust pipe or manifold) 412 configured to provide cathode exhaust from multiple power modules 10 to an optional heat exchanger 420 for heat recovery. In some embodiments, an optional directional valve 310, such as a non-return valve, a flapper valve, or a pressure sensitive valve, may be disposed on exhaust conduit 304C. The directional valve 310 may be configured to prevent exhaust backflow to the power module 10 from the exhaust conduit 412. An optional exhaust fan 422 may be used in some embodiments to force cathode exhaust through the exhaust conduit 412. For example, at least one exhaust fan 422 may be disposed upstream or downstream of the heat exchanger 420, with respect to a cathode exhaust flow direction. However, in other embodiments described below, there are no exhaust fans located downstream of the cathode recuperator.

Water from a water source 206, such as a water tank or a water pipe, flows to the water injector 160 through water conduit 306. The water injector 160 injects water directly into first portion of the anode exhaust provided in anode exhaust conduit 308C. Heat from the first portion of the anode exhaust (also referred to as a recycled anode exhaust stream) provided in anode exhaust conduit 308C vaporizes the water to generate steam. The steam mixes with the anode exhaust, and the resultant mixture is provided to the anode exhaust cooler 140. The mixture is then provided from the anode exhaust cooler 140 to the mixer 210 through the anode exhaust conduit 308E. The mixer 210 is configured to mix the steam and first portion of the anode exhaust with fresh fuel (i.e., fuel inlet stream). This humidified fuel mixture may then be heated in the anode recuperator 110 by the anode exhaust, before being provided to the stack 102. The module 10 may also include one or more fuel reforming catalysts 112, 114, and 116 located inside and/or downstream of the anode recuperator 110. The reforming catalyst(s) reform the humidified fuel mixture before it is provided to the stack 102.

The power module 10 may further a system controller 225 configured to control various elements of the module 10. The controller 225 may include a central processing unit configured to execute stored instructions. For example, the controller 225 may be configured to control fuel and/or air flow through the power module 10, according to fuel composition data.

In some embodiments, the fuel cell stacks 102 may be arranged in the hotbox 100 around a central column including the anode recuperator 110, the ATO 150, and the anode exhaust cooler 140. In particular, the anode recuperator 110 may be disposed radially inward of the ATO 150, and the anode exhaust cooler 140 may be mounted over the anode recuperator 110 and the ATO 150. In one embodiment, an oxidation catalyst 112 and/or the hydrogenation catalyst 114 may be located in the anode recuperator 110. A reforming catalyst 116 may also be located at the bottom of the anode recuperator 110 as a steam methane reformation (SMR) insert.

The power module 10 may also optionally include a first valve 312 configured to control air flow to the CPOx reactor 200 and a second valve 314 configured to control air flow to the anode exhaust cooler 140. The valves 312, 314 may be mass flow controller (MFC) valves, proportional solenoid valves, or the like, for example. In some embodiments, the first valve 312 may be open during system start-up mode (when the CPOx reactor 200 partially oxidizes the incoming fuel), and may be closed during steady-state mode operation (when the fuel flows through the CPOx reactor 200 without being oxidized). In contrast, the second valve 314 may be closed or partially open during system start-up mode, and may be fully open during steady-state mode operation.

In various embodiments and without wishing to be bound by a particular theory, the present inventors determined that the air flow rate and/or the air pressure suitable for ignition of the CPOx reactor 200 may be lower than the air flow rate and/or air pressure suitable for steady-state operation of the stacks 102. As such, the first valve 312 may be configured to operate as a flow restrictor during system start-up mode, in order to limit the amount of air provided to the CPOx reactor 200. For example, the first valve 312 may be configured to provide air flow rates to the CPOx reactor 200 ranging from 0 to about 1000 standard liters per minute (slpm), and the second valve 314 may be configured to provide air flow rates to the anode exhaust cooler 140 which are larger than provided to the CPOx reactor, such as ranging from 0 to about 10,000 slpm.

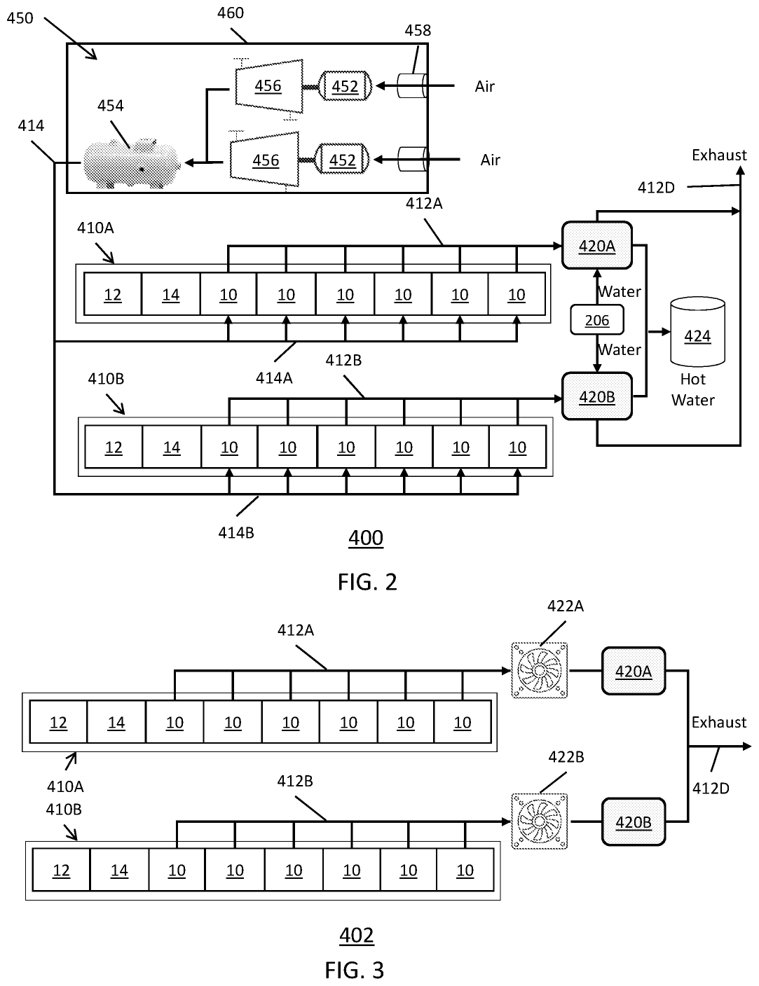

In alternative embodiments, the power module 10 may be fluidly connected to an optional compression system 450 by an air conduit 414, such as a compressed inlet air pipe or manifold. The compression system 450 may be configured to provide pressurized air to the CPOx reactor 200 and/or the anode exhaust cooler 140. Air flow from the compression system 450 may be controlled by the first and second valves 312, 314. In some embodiments, utilizing the compression system 450 to provide pressurized air may allow for the CPOx blower 204 and/or the main air blower 208 to be omitted. The components of the compression system 450 are discussed in detail with respect to FIG. 2.

FIG. 2 is a schematic view of a fuel cell power system 400 including fuel cell power modules 10, such as the power modules illustrated in FIG. 1 or other suitable fuel cell power modules, according to various embodiments of the present disclosure. Referring to FIGS. 1 and 2, the power modules 10 may be disposed in one or more modular system enclosures. For example, as shown in FIG. 2, the power modules 10 may be arranged in rows and disposed in a first system enclosure 410A and a second system enclosure 410B. However, the present disclosure is not limited to any particular number of power modules and/or system enclosures. The system enclosures 410A and 410B may each comprise a plurality of adjacent cabinets located on a common base housing various conduits (e.g., fuel inlet conduits) and electrical connections (e.g., wires and/or buses)

The system enclosures 410A, 410B may also each include a power conditioning module 12 and a fuel processing module 14. The power conditioning modules 12 may including components for converting the fuel cell generated DC power to AC power (e.g., DC/DC and DC/AC converters described in U.S. Pat. No. 7,705,490, incorporated herein by reference in its entirety), electrical connectors for AC power output to the grid, circuits for managing electrical transients, a system controller (e.g., a computer or dedicated control logic device or circuit). The power conditioning modules 12 may be designed to convert DC power from the fuel cell modules to different AC voltages and frequencies. Designs for 208V, 60 Hz; 480V, 60 Hz; 415V, 50 Hz and other common voltages and frequencies may be provided.

The fuel processing modules 14 may include fuel processing components, such as desulfurization beds or the like. The fuel processing modules 14 may be designed to process different types of fuel. For example, a diesel fuel processing module, a natural gas fuel processing module, and an ethanol fuel processing module may be provided in the same or in separate cabinets. A different bed composition tailored for a particular fuel may be provided in each module. The fuel processing modules 14 may processes at least one of the following fuels selected from natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, bio-gas, bio-diesel and other suitable hydrocarbon or hydrogen containing fuels.

The power system 400 may also include the exhaust conduit (e.g., exhaust pipe or manifold) 412 configured to receive cathode exhaust (e.g., ATO 150 exhaust) from the exhaust conduits 304C of the power modules 10. For example, the exhaust conduit 412 may include a first conduit 412A that is fluidly connected to the power modules 10 of the first system enclosure 410A, and a second conduit 412B fluidly connected to the power modules 10 of the second system enclosure 410B.

In some embodiments, such as in marine and/or combined heat and power (CHP) applications, the first exhaust conduit 412A and the second exhaust conduit 412B may be fluidly connected to one or more heat exchangers 420. For example, the first conduit 412A may be configured to provide cathode exhaust to a first heat exchanger 420A, and the second conduit 412B may be configured to provide cathode exhaust to a second heat exchanger 420B. The heat exchangers 420A, 420B may be configured to heat water received from a water source 206 using heat extracted from the cathode exhaust. Heated water output from the heat exchangers 420A, 420B may be stored in a storage tank 424 for later use (e.g., on a marine vessel). In the alternative, the heat exchangers 420A, 420B may be used to pre-heat water that is provided to a steam generator (not shown) or other device that utilizes heated water (e.g., on a marine vessel).

The exhaust conduit 412 may include an outlet conduit 412D that fluidly connects outlets of the heat exchangers 420A, 420B an exhaust outlet. In particular, the outlet conduit 412D may be used to vent the cathode exhaust output from the heat exchangers 420A, 420B to the atmosphere, for example.

The power system 400 may include or be fluidly connected to the compression system 450 configured to provide pressurized air provided to the power modules 10. In particular, the pressurized air may compensate for a pressure drop induced by the heat exchangers 420A, 420B and/or corresponding conduits. The compression system 450 may include at least one air compressor 452 and at least one pressure tank 454. The air compressor 452 may be configured to provide compressed air to the pressure tank 454. For example, air may be stored in the pressure tank 454 at a pressure ranging from about 2 pounds per square inch gauge (psig) to about 20 psig, such as from about 5 psig to about 10 psig, or about 8 psig. The air compressor 452 may be a high efficiency compressor, such as a centrifugal compressor or an axial compressor.

In some embodiments, multiple air compressors 452 (e.g., 2 or more such as 3 to 6 air compressors) may be used to provide compressed air to each pressure tank 454, in order to provide increased system reliability. The air compressors 452 may be powered by power generated by the power modules 10 and/or by other external power (e.g., electric grid power and/or power from engines of a marine vessel).

The compression system 450 may be fluidly connected to the power modules 10 by one or more air conduits (i.e., compressed air conduits) 414. For example, the power system 400 may include a first air conduit 414A that is fluidly connected to the power modules 10 of the first enclosure 410A, and a second air conduit 414B that is fluidly connected to the power modules 10 of the second enclosure 410B. In other embodiments, the air conduits 414A, 414B may comprise manifolds having sufficiently large internal width (e.g., diameter) to store pressurized air for the power modules, such that the pressure tank 454 may be omitted.

In some embodiments, the compression system 450 may optionally include one or more air coolers 456. For example, an air cooler 456 may be disposed downstream of each air compressor 452. The air coolers 456 may be configured to cool the compressed air output from each air compressor 452, prior to the compressed air entering the pressure tank 454. For example, the compression system 450 may include single-stage compressors 452 and no air coolers, single-stage compressors 452 and corresponding air coolers 456, or multi-stage compressors 452 including intercoolers and a final air cooler 456 to remove heat of compression. The compression system 450 may also optionally include air filters 458 upstream of the compressors 452 to prevent contaminants from entering the compressors 452. The air coolers 456 and/or the pressure tank 454 may be configured to discharge any condensed water as a separate product stream.

In various embodiments, the compression system 450 may be disposed in a separate enclosure and/or a separate room (e.g., a separate room on a marine vessel) from the remainder of the power system 400 components, such as the system enclosures 410A and 410B. For example, the compression system may be disposed in a sound-proofed room 460 (e.g., located on a marine vessel) configured to abate noise generated by the compressors 452. For example, the sound-proofed room 460 may include sound-insulating panels or materials configured to reduce the noise generated by the compressors 452 by at least 30 decibels, such as by at least 40-60 decibels.

In some embodiments, the compression system 450 may include multiple pressure tanks 454 that are each provided with compressed air from multiple air compressors 452. In various embodiments, the pressure tanks 454 may be interconnected by one or more conduits, in order to normalize the pressure there between.

The compression system 450 may allow for the omission of some system components. For example, power module blowers, such as the CPOx blower 204 and/or the main air blower 208, may be omitted from the power modules 10. The power system 400 may also omit the exhaust fan 422. As such, system costs may be reduced and system reliability may be increased.

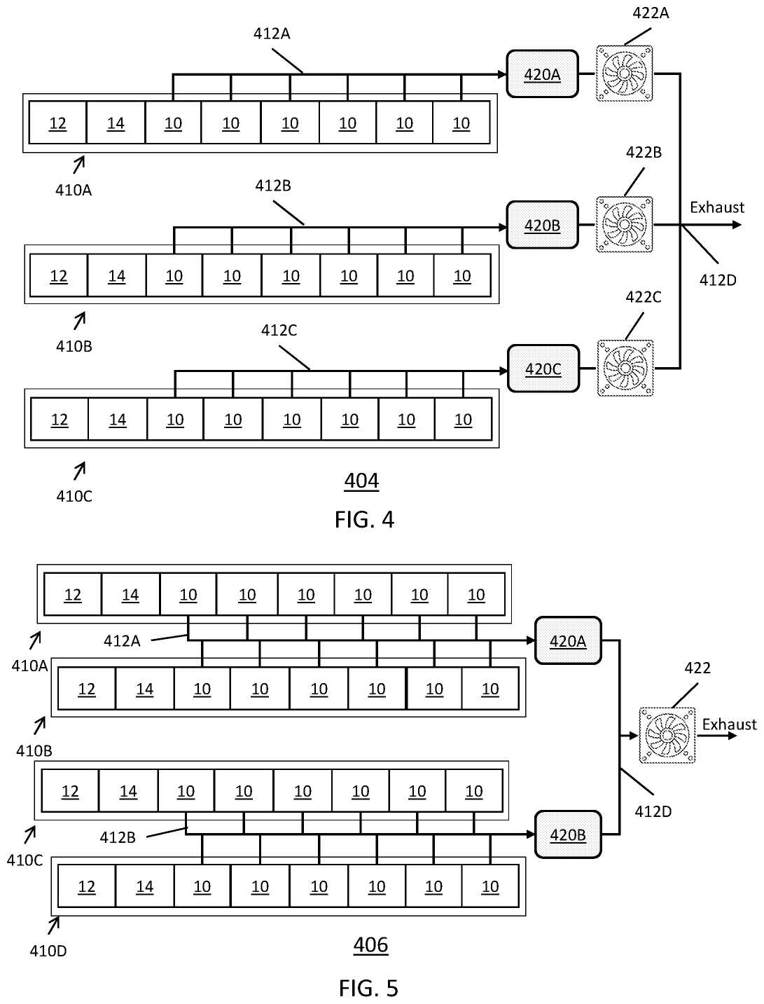

FIG. 3 is a schematic view of a power system 402 including power modules 10, according to an alternative embodiment of the present disclosure. The power system 402 may be similar to the power system 400. As such, only the differences therebetween will be discussed in detail.

Referring to FIGS. 1 and 3, the power modules 10 of the power system 402 may be arranged in rows and disposed in system enclosures, such as a first system enclosure 410A and a second system enclosure 410B. Exhaust conduits 304C of each power module 10 may be connected to an exhaust conduit 412, which may include a first conduit 412A, a second conduit 412B, and an outlet conduit 412D. The first conduit 412A may be configured to provide cathode exhaust to a first heat exchanger 420A, and the second conduit 412B may be configured to provide cathode exhaust to a second heat exchanger 420B.

The power system 402 may optionally include one or more exhaust fans 422 located upstream of the respective heat exchanges and configured to pull cathode exhaust through the exhaust conduit 412. For example, the power system 402 may include a first fan 422A configured to pull cathode exhaust through the first conduit 412A, and a second fan 422B configured to pull cathode exhaust through the second conduit 412B. The fans 422 may be configured to operate at relatively high temperatures found in the cathode exhaust output from the power modules 10. The exhaust fans 422 may also be relatively large due to the lower density of the high temperature cathode exhaust.

Unlike the power system 400, the power system 402 may not be fluidly connected to a compression system, and exhaust flow pressure may be generated using module blowers, such as the CPOx blower 204 and the main air blower 208. In particular, the module blowers may be operated at higher speeds to compensate for a pressure drop induced in the cathode exhaust conduit 412. Although not shown, the power system 402 may include a water source, storage tank, and water conduits, as shown in FIG. 2.

FIG. 4 is a schematic view of a power system 404 including power modules 10, according to various embodiments of the present disclosure. The power system 404 may be similar to the power system 402. As such, only the differences therebetween will be discussed in detail.

Referring to FIGS. 1 and 4, the power system 404 may include first, second, and third system enclosures 410A, 410B, 410C, and an exhaust conduit 412 that includes first, second, and third conduits 412A, 412B, 412C, and an outlet conduit 412D. The system 404 may also include multiple heat exchangers 420, such as first, second, and third heat exchangers 420A, 420B, 420C, and multiple exhaust fans 422, such as first, second, and third fans 422A, 422B, 422C.

The exhaust fans 422 may be disposed downstream of the respective heat exchangers 420. As such, the exhaust fans 422 may be designed to operate at lower temperatures than the exhaust fans 422 of the power system 402. The exhaust fans 422 may also be smaller and/or consume less power than the exhaust fans 422 of the power system 402, because the fans receive cooler, higher-density cathode exhaust from the heat exchangers 420. Although not shown, the power system 404 may include a water source, storage tank, and water conduits, as shown in FIG. 2.

FIG. 5 is a schematic view of a power system 406 including power modules 10, according to various embodiments of the present disclosure. The power system 406 may be similar to the power system 404. As such, only the differences therebetween will be discussed in detail.

Referring to FIGS. 1 and 5, the power system 406 may include first, second, third, and fourth system enclosures 410A, 410B, 410C, 410D, and an exhaust conduit 412 that includes first and second conduits 412A, 412B, and an outlet conduit 412D. The system 406 may also include multiple heat exchangers 420, such as first and second heat exchangers 420A, 420B, and a single exhaust fan 422.

The first and second conduits 412A, 412B may be fluidly connected to power modules of more than one of the system enclosures. For example, the first conduit 412A may be fluidly connected to the power modules 10 of the first and second system enclosures 410A, 410B, and the second conduit 412B may be fluidly connected to the power modules 10 of the third and fourth system enclosures 410C, 410D.

The exhaust fan 422 may be disposed on the outlet conduit 412D, downstream of the heat exchangers 420. The exhaust fan 422 may be configured to induce a draft in the first and second conduits 412A, 412B. Thus, one exhaust fan 422 is used for plural system enclosures. Although not shown, the power system 406 may include a water source, storage tank, and water conduits, as shown in FIG. 2.

FIG. 6 is a schematic view of a power system 408 including power modules 10, according to various embodiments of the present disclosure. The power system 408 may be similar to the power system 402. As such, only the differences therebetween will be discussed in detail.

Referring to FIGS. 1 and 6, the power modules 10 of the power system 408 may be arranged in rows and disposed in system enclosures, such as a first system enclosure 410A and a second system enclosure 410B. Exhaust conduits 304C of each power module 10 may be connected to an exhaust conduit 412, which may include a first conduit 412A, a second conduit 412B, and an outlet conduit 412D.

The power system 408 may omit an exhaust fan, and exhaust flow pressure may be generated using power module blowers, such as the CPOx blower 204 and/or the main air blower 208. In particular, the module blowers may be operated at higher speeds to compensate for a pressure drop induced when flowing through the cathode exhaust conduit 412 and/or the first and second heat exchangers 420A, 420B.

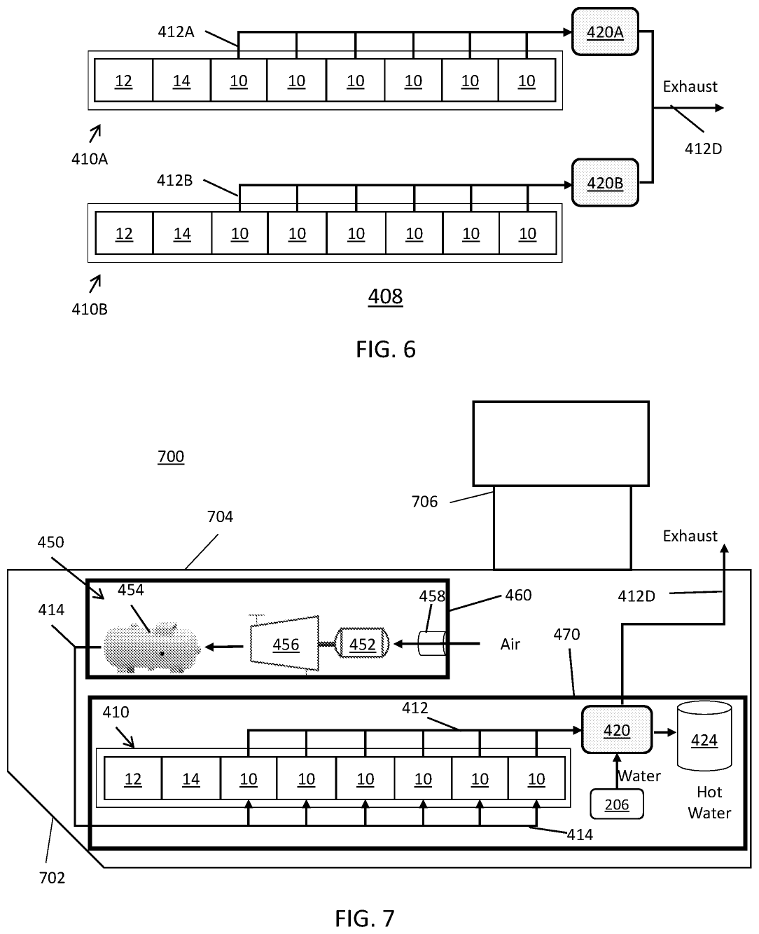

FIG. 7 is a schematic illustration of a fuel cell power system described above, such as the power system 400 located on vessel (i.e., ship) 700. The terms “vessel” and “ship” are used interchangeably herein. The vessel or ship may transport freight and/or passengers. The vessel 700 may include a hull 702 and a deck 704. The vessel 700 may also include a bridge 706. In one embodiment, the vessel 700 may be a marine vessel configured to operate in seas and oceans. However, vessels 700 configured to operate in rivers and lakes may also be used. As shown in FIG. 7, the compression system 450 is located in a first room 460, such as the sound proof room on the ship 700 as described above, while the system enclosure 410 containing the fuel cell power modules 10 is located in a second room 470 on the ship 700 than the first room 460.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A power system, comprising:
power modules comprising stacks of fuel cells;
a compression system configured to generate compressed air;
an air conduit configured to transfer compressed air from the compression system to the power modules;
a heat exchanger configured to extract heat from cathode exhaust generated by the power modules; and
an exhaust conduit configured to transfer the cathode exhaust from the power modules to the heat exchanger.

2. The power system of claim 1, wherein the compression system comprises:
a pressure tank configured to store compressed air; and
an air compressor configured to provide compressed air to the pressure tank.

3. The power system of claim 2, wherein the compression system further comprises an air cooler configured to cool compressed air provided from the compressor to the pressure tank, wherein at least one of the air cooler or the pressure tank are configured to discharge condensed water as a separate product stream.

4. The power system of claim 2, wherein the compression system further comprises an air filter configured to filter ambient air provided to the compressor.

5. The power system of claim 1, wherein the compression system comprises:
a first pressure tank configured to store compressed air;
at least two air compressors configured to provide compressed air to the first pressure tank; and
at least two air coolers configured to cool compressed air provided from the at least two compressors to the first pressure tank.

6. The power system of claim 5, further comprising:
a second pressure tank configured to store compressed air; and
at least two additional air compressors configured to provide compressed air to the second pressure tank,
wherein the first and second pressure tanks are fluidly connected.

7. The power system of claim 1, wherein the power modules do not include module air blowers.

8. The power system of claim 2, wherein:
the compression system is disposed in a sound-proofed first room configured to reduce noise generated by the compressors by at least 30 decibels; and
the power modules are disposed in a second room different from the first room.

9. The power system of claim 1, wherein the first room and the second room are located on a ship.

10. The power system of claim 1, wherein the power modules each comprise:
a catalytic partial oxidation (CPOx) reactor;
a first air inlet conduit fluidly connecting the air conduit to the CPOx reactor;
an anode exhaust cooler heat exchanger in which is configured to heat inlet air with anode exhaust from the stacks;
a second air inlet conduit fluidly connecting the air conduit to the anode exhaust cooler heat exchanger;
a first valve configured to control air flow through the first air inlet conduit; and
a second valve configured to control air flow through the second air inlet conduit.

11. The power system of claim 10, wherein the first valve comprises a flow restrictor valve which is configured to provide a first flow rate of air to the first air inlet conduit, and the second valve is configured to provide a second flow rate of air greater than the first flow rate of air to the second air inlet conduit.

12. The power system of claim 11, the power modules each comprise a system controller configured to control the first and second valves, such that:
during start-up mode of the power system, a first amount of compressed air is provided to the CPOx reactor until the CPOx reactor is ignited, and then a larger second amount of the compressed air is provided to the CPOx reactor until the power system enters a steady-state mode; and
during the steady-state mode, no air is provided to the CPOx reactor and a third amount of air is provided to the anode exhaust cooler, the third amount of air being larger than the second amount of air.

13. The power system of claim 1, wherein the power modules each comprise:
a cathode recuperator heat exchanger configured to heat the inlet air with the cathode exhaust from the stacks;
an exhaust conduit fluidly connecting the cathode recuperator to the exhaust conduit; and
a non-return valve configured to prevent to prevent backflow of cathode exhaust from the exhaust conduit to the cathode recuperator.

14. The power system of claim 1, wherein the heat exchanger is configured to heat water using heat extracted from the cathode exhaust.

15. A power system, comprising:
power modules comprising stacks of fuel cells;
a heat exchanger configured to extract heat from cathode exhaust generated by the power modules;
an exhaust conduit configured to transfer the cathode exhaust from the power modules to the heat exchanger; and
a fan configured to force cathode exhaust through the exhaust conduit.

16. The power system of claim 15, wherein the fan is disposed upstream of the heat exchanger with respect to a cathode exhaust flow direction through the exhaust conduit.

17. The power system of claim 15, wherein the fan is disposed downstream of the heat exchanger with respect to a cathode exhaust flow direction through the exhaust conduit.

18. A method of operating power system, comprising:
generating compressed air;
providing the compressed air and fuel to fuel cell power modules; and
providing a cathode exhaust from the power modules to a heat exchanger.

19. The method claim 18, further comprising heating water on a ship in the heat exchanger using the cathode exhaust.

20. The method of claim 18, further comprising:
cooling the compressed air and storing the cooled compressed air prior to providing the compressed air to the fuel cell power modules; and
generating electrical power in the fuel cell power modules using the fuel and the compressed air.
